(19) United States
(12) Patent Application Publication
(10) Pub. No.: US 2006/0022812 A1
(43) Pub. Date: Feb. 2, 2006

(54) Integrated vehicle overturn alarm device

(76) Inventor: Rick Lang, San Clemente, CA (US)

Correspondence Address: Karl M. Steins;Steins & Associates, Suite 120, 2333 Camino del Rio South, San Diego, CA, 92108, US

(21) Appl. No.: 11/236,005

(22) Filed: Sep. 27, 2005

Related U.S. Application Data
(63) Continuation-in-part of application No. 10/864,931, filed on Jun. 9, 2004.

(51) Int. Cl. B60Q 1/00

(52) U.S. Cl. 340/440

(57) ABSTRACT

A Integrated Vehicle Overturn Alarm Device is disclosed. The device is self-contained and include a sensor to detect when a vehicle rollover has occurred, and a loud audible alarm to alert other individuals of the incident. The device is contained within a water-resistant housing to make the device particularly applicable to the off-road vehicle environment. The device further includes a plurality of attachment appurtenances to provide flexibility in where and how it is attached to the vehicle. An alternate version of the invention is an original equipment feature installed in an all-terrain vehicle.

This invention is a continuation-in-part of application Ser. No. 10/864,931, filed Jun. 9, 2004, currently pending.

### BACKGROUND OF THE INVENTION

1. Field of the Invention

This invention relates generally to vehicle safety systems and, more specifically, to an Integrated Vehicle Overturn Alarm Device.

2. Description of Related Art

Riding All-terrain vehicles (ATV's) and all-terrain cycles (ATC's) is an extremely popular recreational activity. Most motorcycle manufacturers offer a variety of models for virtually all age, experience and size of rider. One significant safety problem exists with these vehicles—the hazard of tipping or rolling the vehicle over. Even the most seasoned ATV/ATC rider can encounter unexpected terrain or hazards that may pitch the vehicle to the side far enough so that the vehicle and rider(s) roll over. Since the average ATV/ATC weighs several hundred pounds, if it rolls onto a rider, it can be harmful and even fatal.

While it is typical for riders to stay together in groups, or at least to join friends for weekends of off-roading, it is also common for individuals to become separated from their peers in the course of their ride. Being separated from his or her co-riders makes the ATV/ATC experience even more dangerous. If a sole rider becomes pinned under a rolled or tipped vehicle, it is very possible that his or her co-riders won't even know of the incident. Furthermore, since the terrain used for off-roading is generally very hilly, riders on the ground may not even be able to find their downed co-rider.

What is needed, then, is a device that detects when an ATV/ATC (or other vehicle) rolls or tips, and then responsively transmits an audible alert that can be easily heard by individuals in the vicinity of the rolled or tipped vehicle.

### SUMMARY OF THE INVENTION

In light of the aforementioned problems associated with the prior devices and systems, it is an object of the present invention to provide a Integrated Vehicle Overturn Alarm Device. The device should be self-contained and include a sensor to detect when a vehicle rollover has occurred, and a loud audible alarm to alert other individuals of the incident. The device should be contained within a water-resistant housing to make the device particularly applicable to the off-road vehicle environment. The device should further be provided with a plurality of attachment appurtenances to provide flexibility in where and how it is attached to the vehicle.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a conventional all-terrain vehicle;

FIG. 2 is a front perspective view of a preferred embodiment of the vehicle rollover alert device of the present invention;

FIG. 3 is a rear perspective view of the vehicle rollover alert device of FIG. 2;

FIG. 4 is a schematic diagram of the electrical circuit one embodiment of the device of FIGS. 2 and 3;

FIG. 5 is a schematic diagram of the electrical circuit of another embodiment of the device of FIGS. 2 and 3; and

FIG. 6 is a perspective view of the device of FIGS. 2-5 attached to a conventional ATV.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Integrated Vehicle Overturn Alarm Device.

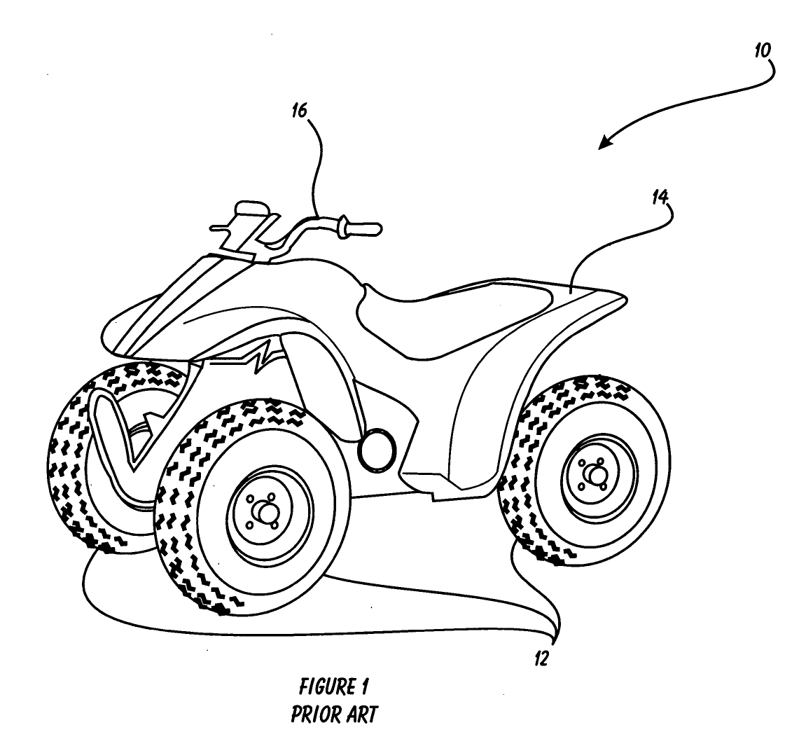

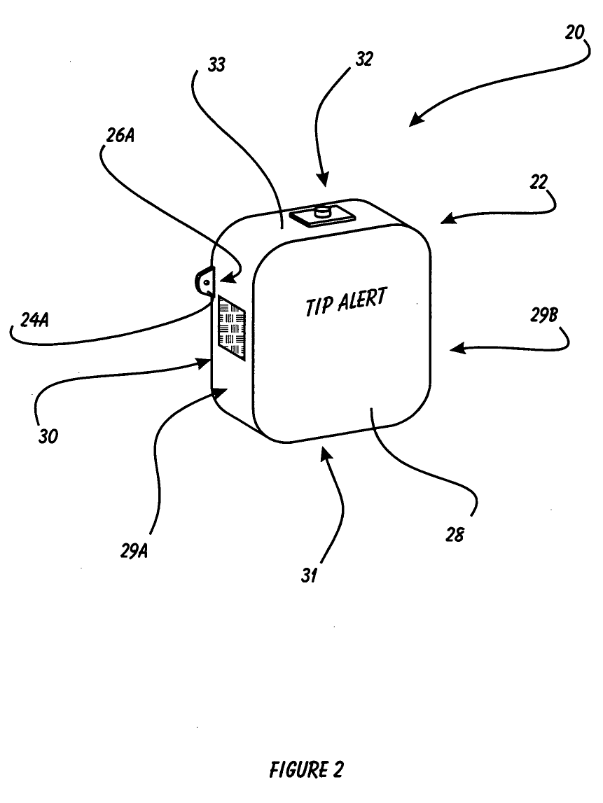

The present invention can best be understood by initial consideration of FIG. 1. FIG. 1 is a perspective view of a conventional all-terrain vehicle (ATV) 10. The major difference between an ATV and an ATC is that an ATV has four or more wheels 12, while an ATC only has two or three wheels. The rider of an ATV sits atop a seat provided at the rear of the body 14. Steering of the ATV is accomplished via handlebars 16. Now turning to FIG. 2, we can begin discussing the present invention.

FIG. 2 is a front perspective view of a preferred embodiment of the vehicle rollover alert device 20 of the present invention. The working parts of the device 20 are enclosed within a housing 22. The housing 22 is preferably sealed to be water- and dirt-resistant. As such, all switches or openings in the housing 22 are sealed to the outside environment. In a non-depicted version, the housing 22 is actually filled with epoxy in order to protect all of the internal components from moisture or dirt damage.

The housing 22 is defined by a front face, two side faces 29A and 29B, a bottom face 31, and a top face 33. An audible alert device 30 is either contained within the housing 22, or attached to the outside thereof. The audible alert device 30 provides a loud noise when the device 20 is tipped to the side and/or is rolled over and remains in that position for a preset period of time. An alarm reset button 32 is disposed on the top surface 33 of the housing 22. If the alarm sounds, it will continue to alert until either the internal power supply runs out of power, or the reset button 32 is depressed. If the audible alert device 30 is enclosed within the housing 22, there will be one or more apertures formed in the wall of the housing to enable the device 30 to be heard clearly. These apertures would be sealed from the inner components of the device 20 in order to protect them from water and dirt.

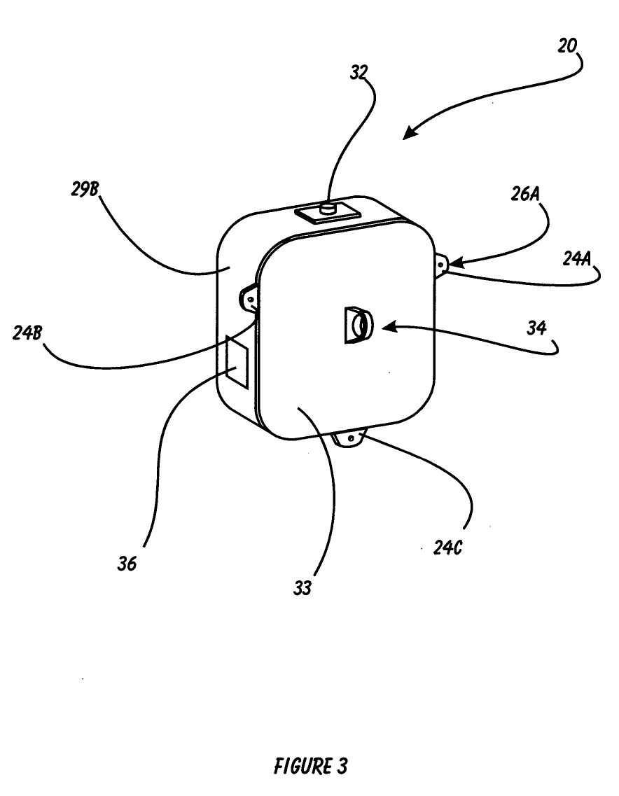

Also shown here is a first mounting tab 24A extending from the side of the housing 22. The tab 24A has one or more mounting apertures formed in it to accept a screw, bolt or the like for attaching the device 20 to an ATV, ATC or other vehicle. Now we shall turn to FIG. 3 to continue to explore this invention.

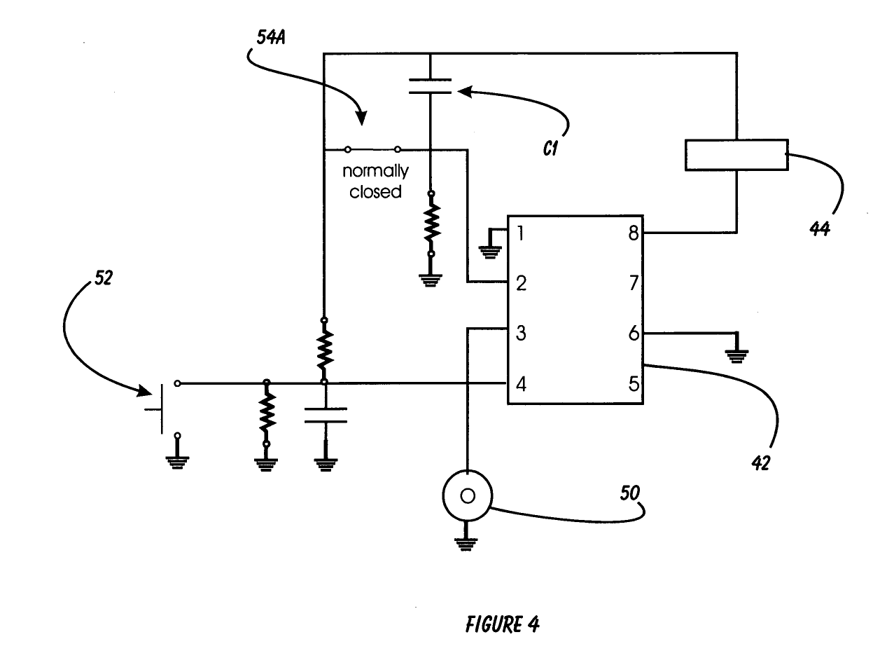

FIG. 3 is a rear perspective view of the vehicle rollover alert device 22 of FIG. 2. In this version, a battery access door 36 is provided on the second side face 29B for access to the internal power supply for maintenance. Second and third mounting fins 24B and 24C are also shown here on the side face 29B and bottom face, respectively. The housing 22 is further defined by a rear face 33. The rear face 33 may have a mounting clamp 34 extending outwardly from it to provide yet another mounting option for the user. FIG. 4 provides detail regarding the functional components of the device 20

FIG. 4 is a schematic diagram of the electrical circuit one embodiment of the device of FIGS. 2 and 3. In most embodiments, substantially all of the components depicted here are contained within a single housing—this provides a unique, compact and easily installable on or in virtually any vehicle.

The audible sound is provided by a sound device/element 50. One choice would be a piezo element—piezo elements are known to be compact and durable, and yet able to provide sounds in excess of 130 dB in magnitude. The piezo element 50 is activated by the processor device 42 (in this embodiment, a 555 timer device), and powered by the internal power supply 44.

The processor device 42 obtains inputs from a position sensor device 54. The position sensor 54A provides an alarm input to the processor device 42 whenever the sensor 54A is tipped or overturned (when power is supplied to the sensor 54). In this version, capacitor C1 also provides a delay prior to the alarm being sounded after the sensor 54A is tipped. Changing the size of the capacitor C1 will result in a change in the duration of this delay. The delay circuit is provided to prevent inadvertent alarming such as due to riding over bumps, etc.

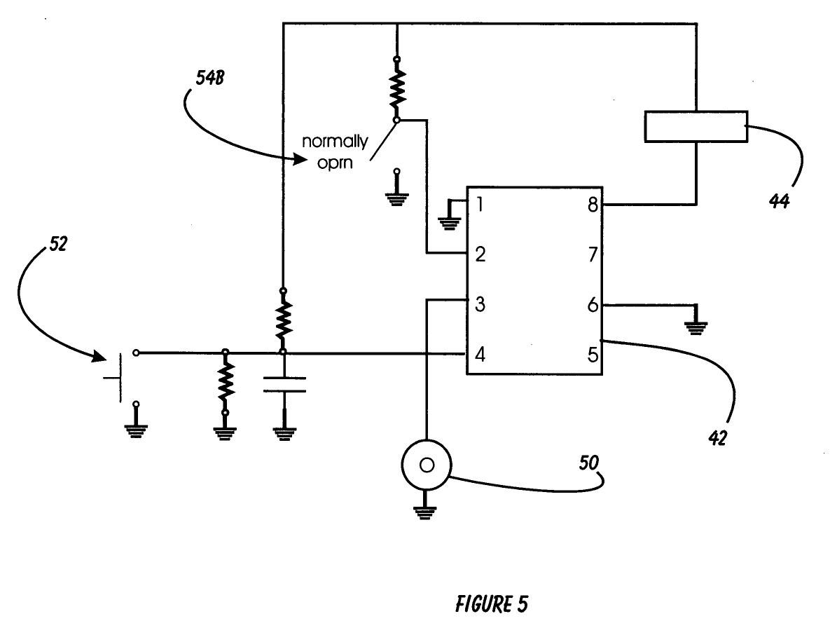

The reset switch 52 is operatively associated with the reset button discussed above in connection with previous drawing figures. It operates to trigger the processor device to stop an activated alarms from sounding. Once an audible alert begins sounding, only the reset switch 52, or removal or discharge of the internal power source will stop the alarm from sounding. A ready indicator lamp (not shown), such as an LED is provided to give the user an indication that the unit is in operating condition. Turning to FIG. 5, we can examine another embodiment of the circuit of the present invention.

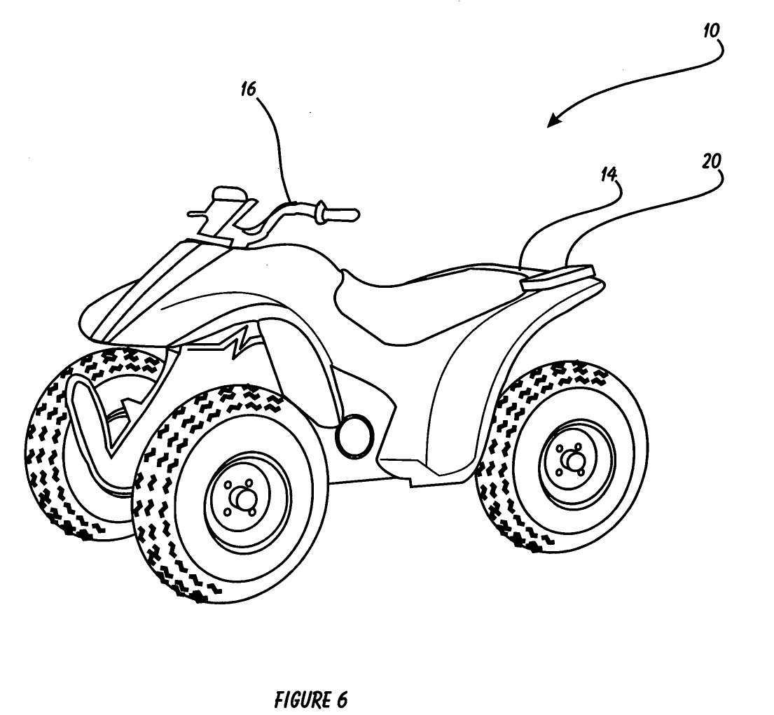

FIG. 5 is a schematic diagram of the electrical circuit of another embodiment of the device of FIGS. 2 and 3. This version has a normally open tilt switch 54B. This version does not include a delay between switch 54B trigger and the audible alert sounding. The audible alert will remain on until such time as the reset switch 52 is opened, or the battery 44 runs out of power. Finally, turning to FIG. 6, we can examine the device in use.

FIG. 6 is a perspective view of the device of FIGS. 2-5 attached to a conventional ATV. In this depiction, the device 20 is attached to the body 12 of the ATV via the mounting clamp 34. Alternatively, the device 20 could be attached to a fender or other location on the body or chassis of the vehicle.

In another (non-depicted) version of the present invention, the device is implemented within an original equipment off-road or all-terrain vehicle (e.g. a convention ATV). In such a circumstance, the spacial sensor, audible alarm and visual alarm will all be located in water-resistant casings. These components may be contained in one master housing, or in individual component housings. Similarly, the reset button my be located separate from the other components of the device, such as on the handlebars of the ATV. This “OEM” version of the present invention would use power from the main vehicle battery for it's main power source, but it may further have an auxiliary backup battery associated with it to provide for the possibility of catastrophic damage to the ATV and/or it's electrical system. If there was a secondary (water-resistant) power source for the vehicle overturn alarm, then the alarm would operate even where the main power to the ATV is interrupted.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An off-road vehicle and vehicle overturn alarm device combination, comprising:
an off-road vehicle, comprising a portable power source and defining an upright position; and
a vehicle overturn alarm device, comprising:
a housing;
a position sensor enclosed in said housing, said position sensor sensitive to spacial orientation, namely whether said off-road vehicle is in said upright position;
audible alarm means for sounding an alarm that is audible to the human senses responsive to said position sensor; and
processing means powered by said power source and operatively connected to said position sensor and said audible alarm means.

2. The device of claim 1, wherein said housing is defined by an inner chamber housing said position sensor and said alarm means, and an outer surface, said housing being substantially water resistant to prevent moisture entering from said outer surface into said inner chamber.

3. The device of claim 2, wherein said housing is further defined by a mounting fin extending therefrom, said mounting fin defining a flat portion extending outwardly from said housing and further defined by a mounting aperture formed therethrough.

4. The device of claim 3, further comprising a pair of said mounting fins, each said fin extending from opposing sides of said housing.

5. The device of claim 4, further comprising a third mounting fin extending downwardly from a bottom surface of said housing.

6. The device of claim 5, wherein said housing is further defined by a rear face, said device further comprising a clamp disposed on said rear face.

7. The device of claim 6, wherein said clamp comprises a first clamp-half extending from said rear face and a second clamp-half attachable to said first clamp-half.

8. The device of claim 7, further comprising reset switch means operatively connected to said processing means for accepting user input to silence a said audible alarm.

9. The device of claim 8, further comprising a waterproof reset button disposed on said outer surface of said housing for activating said reset switch means.

10. An off-road vehicle, comprising:
a chassis;
a body attached to said chassis;
a plurality of drive wheels;
an engine for driving said drive wheels;
a portable power source associated with said chassis and operatively connected to said engine;
steering means for steering said vehicle; and
a vehicle overturn alarm device, comprising:
a housing defining an interior volume and at least one opening into said interior chamber, each said opening defining a cover, each said cover having a water resistant seal between said cover and said housing, said housing operatively attached to said chassis or said body;
a position sensor enclosed in said housing, said position sensor sensitive to spacial orientation;
processing means powered by said power source and operatively connected to said position sensor; and
audible alarm means for sounding an alarm that is audible to the human senses responsive to said processing means, said alarm means attached to said housing.

11. The vehicle of claim 10, wherein said position sensor and said alarm means are contained within said inner chamber.

12. The vehicle of claim 11, further comprising reset switch means operatively connected to said processing means for accepting user input to silence a said audible alarm.

13. The vehicle of claim 12, wherein said housing is further defined by a rear face, said device further comprising a clamp disposed on said rear face.

14. The vehicle of claim 13, wherein said clamp comprises a first clamp-half extending from said rear face and a second clamp-half attachable to said first clamp-half.

15. The vehicle of claim 14, further comprising a waterproof reset button disposed on said outer surface of said housing for activating said reset switch means.

16. The vehicle of claim 15, wherein said housing is further defined by a mounting fin extending therefrom, said mounting fin defining a flat portion extending outwardly from said housing and further defined by a mounting aperture formed therethrough.

17. The vehicle of claim 16, further comprising a pair of said mounting fins, each said fin extending from opposing sides of said housing.

18. The vehicle of claim 17, further comprising a third mounting fin extending downwardly from a bottom surface of said housing.

19. The vehicle of claim 10, further wherein:
said steering means comprises handlebars operatively connected to a pair of front said drive wheels;
said position sensor is configured to detect when said vehicle is in an unacceptable spacial orientation; and
said processing means is configured to activate said audible alarm means when said position sensor detects said unacceptable vehicle spacial orientation.
